(19) United States
(12) Patent Application Publication
(10) Pub. No.: US 2025/0067445 A1
(43) Pub. Date: Feb. 27, 2025

(54) AN APPARATUS FOR TEMPERATURE REGULATION IN A BUILDING AND A HYBRID VENTILATION SYSTEM AND A METHOD WITH SUCH APPARATUS

(71) Applicant: Syddansk Universitet, Odense M (DK)

(72) Inventor: Mads Høi Rasmussen, Odense M (DK)

(21) Appl. No.: 18/724,979

(22) PCT Filed: Dec. 21, 2022
(86) PCT No.: PCT/EP2022/087189

§ 371 Date: Jun. 27, 2024

(30) Foreign Application Priority Data
Jan. 5, 2022 (EP) 22150287.5

(51) Int. Cl. F24F 1/0035; F24F 5/00; F24F 7/00; F24F 12/00

(52) U.S. Cl. CPC F24F 1/0035; F24F 5/0021; F24F 7/00; F24F 12/006; F24F 2007/005

(57) ABSTRACT

A heat exchanger apparatus for temperature regulation in a building an inlet section with a wedge-shaped inlet channel having a wide opening at an air inlet and a gradually narrowing cross-section. The inlet channel has a side-opening towards a heat exchange section. The heat exchange section has plate-shaped phase change material modules mounted in an inclined stacked formation forming a series of air channels between the PCM modules extending from the inlet section to the wedge-shaped outlet section so that the airflow is gradually redirected from the inlet section and into the air channels of the heat exchange section. The heat exchanger with PCM plate modules has a low pressure drop meaning low additional energy consumption, and the heat exchanger has a very even airflow offering a system that provides effective cooling until all energy stored in the PCM plate modules is dispatched.

### CROSS-REFERENCE TO RELATED APPLICATIONS

This application is the U.S. National Stage of PCT/EP2022/087189 filed on Dec. 21, 2022, which claims priority to European Patent Application 22150287.5 filed on Jan. 5, 2022, the entire content of both are incorporated herein by reference in their entirety.

### FIELD OF THE INVENTION

The present invention relates to a heat exchanger apparatus for temperature regulation in a building and a hybrid ventilation system and a method of temperature regulation in a building with such apparatus.

### BACKGROUND OF THE INVENTION

In the art it is known to use phase change materials (PCM) in systems for temperature regulation in a room in a building.

A phase change material (PCM) is a substance which releases/absorbs sufficient energy at phase transition to provide useful heat/cooling. Generally the transition will be from one of the first two fundamental states of matter—solid and liquid—to the other. By melting and solidifying at the phase change temperature (PCT), a PCM is capable of storing and releasing large amounts of energy compared to sensible heat storage. Heat is absorbed or released when the material changes from solid to liquid and vice versa or when the internal structure of the material changes; PCMs are accordingly referred to as latent heat storage (LHS) materials.

WO 2013/019113 A1 discloses a climate system for buildings and comprises heat storage with a heat exchanger assembly comprising a plurality of plate shaped phase change material (PCM) units. In the system air flows through a channel wherein a heat exchanger unit is mounted. This unit comprise a series of PCM units, and in some embodiments disclosed in WO 2013/019113 A1, the plurality of PCM units are assembled as a box-like unit and mounted in an inclined configuration in the channel with an angle between 5 and 45 degrees with respect to the incoming air direction.

WO 2013/191554 A2 discloses a container for PCM, a PCM unit and PCM module having a series of PCM units and a climate system comprising a PCM module. The PCM units are arranged such that the incoming air flow is directed around the PCM units in a particular way.

WO 2010/092391 A1 discloses a fluid conditioning arrangement with PCM modules for ambient temperature control in buildings.

A large amount of electricity is consumed for temperature regulation of buildings around the world, either for heating the building or ventilating and cooling the building. The concept of utilising PCM based systems are known, so that energy can be stored and used for cooling the building without using electricity. However, these known systems are found to be bulky in design and somewhat inefficient and may be difficult to maintain.

It is an object of the present invention to provide an improvement of the prior art PCM heat exchangers.

It is further an object to provide a hybrid cooling system using such PCM heat exchanger.

### SUMMARY OF THE INVENTION

The invention comprises in a first aspect an apparatus for temperature regulation in a building, comprising a housing accommodating an inlet section receiving an airflow in a first direction, and an outlet section with a heat exchange section therebetween, wherein said inlet section is provided in a first side of the housing, where the inlet section has a wedge-shaped inlet channel having a wide opening at an air inlet and a gradually narrowing cross-section downstream thereof thereby funneling the air downwards in the inlet section, and wherein said inlet channel is provided with a side-opening towards the heat exchange section, and said heat exchange section comprises a plurality of plate-shaped phase change material (PCM) modules mounted in an inclined stacked formation forming a series of air channels between said PCM modules extending from the inlet section to the outlet section are formed between the PCM modules and so that the airflow is gradually redirected from the inlet section and into the air channels of the heat exchange section, whereby the airflow is subjected to the temperature of the PCM modules before exiting the heat exchange section into the outlet section, and said outlet section is a wedge-shaped outlet section provided in a second side of the housing opposite the first side and with a side opening receiving the second air flows from the heat exchange section and directing the air to an outlet channel at the wide end of said wedge-shaped outlet section, and that said wedge-shaped outlet section is pointing in an opposite direction than the wedge-shape of the inlet section.

By the first aspect of the invention there is provided a PCM based cooling system in the form of a heat exchanger with PCM plate modules that has low pressure drop meaning low additional energy consumption used to guide the air through the heat exchanger. The heat exchanger has very even airflow offering a system that provide effective cooling until all energy stored in the PCM plate modules is dispatched and that the energy is dispatched essentially simultaneous for all the PCM plate modules. The heat exchanger has a space-saving compact design allows for easy integration and has a modular design that can fit small and large buildings easily. Moreover, it has fine serviceability which allows for easy cleaning of the PCM containers/plate modules.

During the day outside air of an elevated temperature relative to the phase change temperature (PCT) of the PCM modules may be drawn into the apparatus and cooled before entering the building by melting the PCM of the plate modules. During the night, where the outside temperature is lower than the PCT and then the PCM modules heats up the incoming air to near the phase change temperature as the PCM solidifies.

The inlet channel has an inclination angle β, which is preferably between 3° and 25°. The most suitable angle β depends on the size of the heat exchanger apparatus, particularly the proportions thereof. This angle is particularly selected in order to ensure an evenly distributed airflow through all of the PCM plate modules so that all PCM models are exposed to the airflow evenly and thus changes their phase simultaneously.

Preferably, the air channels between the PCM plates are substantially parallel and providing an airflow in a direction substantially perpendicular to the first airflow direction of the inlet. This ensures a compact design of the apparatus and a satisfying airflow through the heat exchanger section of the apparatus. Similarly, it is advantageous that also the outlet section is wedge-shaped with the outlet channel at the wide end of said wedge-shaped outlet section, and where the outlet section has an inclination angle β, and preferably β being between 3° and 25°, i.e. preferably the same wedge angle β as the inlet section. This allows for a very compact design of the heat exchanger apparatus as well as a design that ensures a good airflow through the heat exchanger. In a particular embodiment, the airflow out of the outlet section is substantially in the second airflow direction, and preferably substantially horizontal whereas the first inlet airflow is substantially vertically downwards. Hereby, the compact design is achieved with a good and even air distribution through the PCM plate modules.

Preferably an air flow generator, such as an air blower, is provided for controlling an airflow into the inlet channel. This air flow generator may be provided upstream the air inlet section for providing an airflow into the inlet channel. Alternatively, the air flow generator may be provided downstream the outlet section for providing an airflow into the inlet channel.

Advantageously, the air flow generator is capable of reversing the airflow through the heat exchanger. Hereby, the PCM modules may be “recharged” by forcing a reverse airflow through the PCM heat exchanger section where the air is either cooler or hotter than the PCT of the PCM modules.

Advantageously, the plate-shaped phase change material (PCM) modules are provided in parallel in the stacked formation. Hereby, a compact apparatus can be achieved.

In a preferable embodiment, the apparatus is accommodated in a box-shaped housing and wherein the plurality of plate-shaped phase change material (PCM) modules are mounted in an inclined stacked formation with a shape of a parallelogram. Hereby, a particularly compact design of the PCM heat exchanger apparatus is achieved.

Preferably, the plate-shaped phase change material (PCM) modules are provided with circumferential rims and are accommodated in a rack, where the side of the inlet section and the side of the outlet section are provided with rail supports for receiving the rims of the PCM modules. This design allows for a particularly service-friendly heat exchanger apparatus.

Preferably, the housing is provided with side covers that retain the plate-shaped PCM modules in said rack and provides an airtight seal between the plate-shaped PCM modules. Hereby the “false” airflows to the side of the plates are prevented and a design allowing for a particularly easy service and maintenance of the plate modules in the rack is provided.

In some preferred embodiments, the phase change material of the PCM modules is adapted for phase change at 10°-25° Celsius. The particular temperature for the phase change, the phase change temperature (PCT) may be chosen in accordance with the specific requirements for the climate in the building in which the heat exchange system is to be installed. Since the phase change temperature is material specific, accordingly the specific material in the PCM plate modules is also to be chosen for the specific use of the heat exchanger.

In a second aspect of the invention, there is provided a hybrid PCM-A/C ventilation. In this aspect, the invention discloses a ventilation system for temperature regulation in a building or at least a section of the building, said system comprising a phase change material (PCM) based heat exchanger apparatus as disclosed in relation to the first aspect, and which comprises PCM modules for receiving an incoming airflow wherein the incoming airflow is subjected to the temperature of the PCM modules to cool the airflow; an electrically powered air conditioning (A/C) system for optionally providing further cooling of at least the cooled supply air to a lower third temperature before reintroducing the air to the building section; and wherein a by-pass flow passage is provided adapted for the A/C system to receive a by-pass airflow of supply air, which is by-passed the PCM heat exchanger apparatus in addition to the cooled supply air from the PCM heat exchanger apparatus.

By providing the PCM based cooling system in in series with a traditional A/C system, a significant saving in the electricity consumption for cooling and heating a building may be achieved. Only when the cooling power is insufficient from the PCM heat exchanger, the A/C may be turned on. Hereby a significant saving of electrical power may be achieved.

Advantageously, the system further comprises a control unit for controlling the temperatures and the airflows of the PCM heat exchanger as well as controlling the A/C system. By controlling the airflows a precise temperature regulation may be achieved, In particular, by controlling the airflows so that only a partial airflow is exposed to the cooling of the PCM heat exchanger apparatus, and a by-pass airflow circumvents the PCM cooling, the system may also provide a temperature regulation below the temperature of the incoming outside air but above the phase change temperature of the PCM heat exchanger apparatus.

In one embodiment of the second aspect of the invention, the system further comprises a first temperature regulation unit for receiving an incoming outdoor airflow and extract airflow from the building, and wherein said air flows are mixed and thereby subjected to a first temperature regulation in accordance with a predetermined room temperature to produce a supply airflow with an intermediate temperature, and an exhaust airflow; and a second temperature regulation unit adapted for receiving the supply airflow, wherein said second temperature regulation unit is the PCM based heat exchanger apparatus. This may provide temperature regulation reusing extracted air from the building to pre-heat or cool the incoming air prior to the PCM heat exchanger system and/or the A/C system.

Associated with the second aspect, the invention also comprise a third aspect of the invention where there is provided a method of regulating the temperature in a building or at least a section of the building, wherein an incoming airflow, which at least in a partial airflow is supplied to a PCM based heat exchanger subjecting the airflow to a temperature regulation, such as cooling; and then feeding at least a portion of the airflow to an electrically powered air conditioning system for a third temperature regulation before reintroducing the air to the building section, and whereby a by-pass flow passage is provided so that a by-pass airflow of supply air may be received, which is by-passed the PCM heat exchanger apparatus in addition to the cooled supply air from the PCM heat exchanger apparatus.

### BRIEF DESCRIPTION OF THE FIGURES

In the following the invention is described in more detail with reference to the accompanying drawings, in which:

FIG. 1 is a schematic side view of a heat exchanger apparatus according to an embodiment of the invention;

FIG. 2 is a perspective view of same with side cover removed;

FIG. 3 is a detailed view of the mounting of the PCM plate modules in the heat exchanger apparatus of FIG. 1;

FIG. 4 is a schematic illustration of a ventilation system according to an embodiment of the invention; and

FIG. 5 is a schematic illustration of another embodiment of a ventilation system according to the invention.

### DETAILED DESCRIPTION OF AN EMBODIMENT

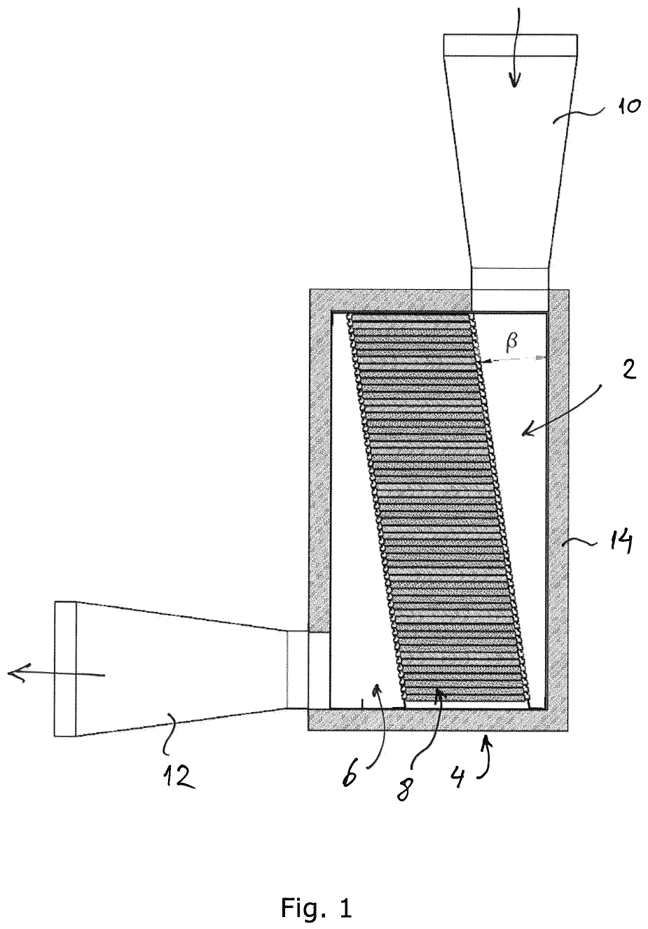

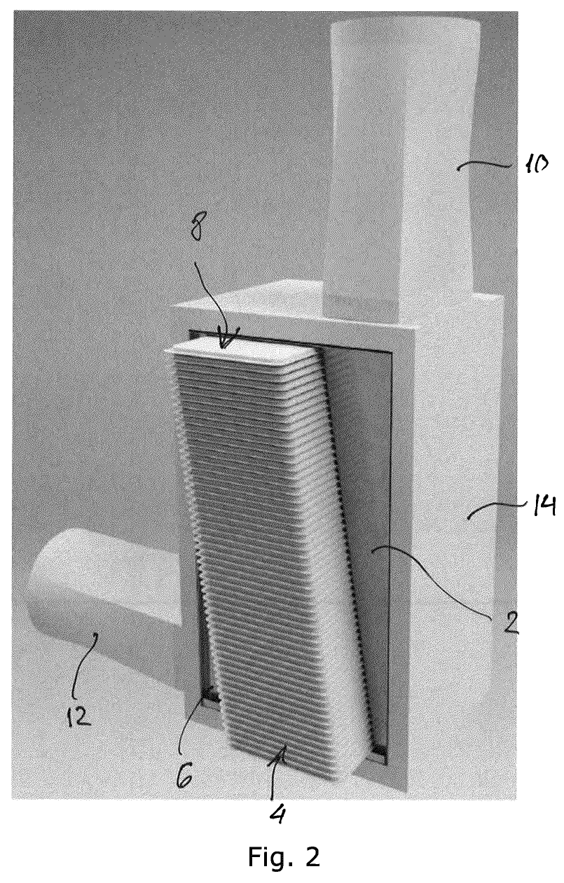

With reference to FIGS. 1-3, an apparatus for temperature regulation in a building according to an embodiment of the invention is shown. The apparatus comprises an inlet section 2 receiving an airflow of incoming air in a first direction, and an outlet section 6 with a heat exchange section 4 there between. These sections—i.e. the inlet 2, heat exchanger 4 and outlet 6—are arranged in a housing 14, which has a compact box shape (see FIG. 2). On the top of the housing 14 there is provided an air inlet 10 guiding the incoming air into the inlet section 2, which has a wedge-shaped inlet channel having a wide opening at an air inlet 10 and a gradually narrowing cross-section downstream thereof. The inlet channel 2 is provided with a side-opening towards the heat exchange section 4.

The heat exchange section 4 comprises a plurality of plate-shaped phase change material (PCM) modules 8 mounted in a stacked formation forming a series of air channels 40 between said PCM modules extending from the inlet section to the outlet section are formed between the PCM modules and so that the airflow is gradually redirected from the inlet section and into the air channels of the heat exchange section, whereby the airflow is subjected to the temperature of the PCM modules before exiting the heat exchange section into the outlet section.

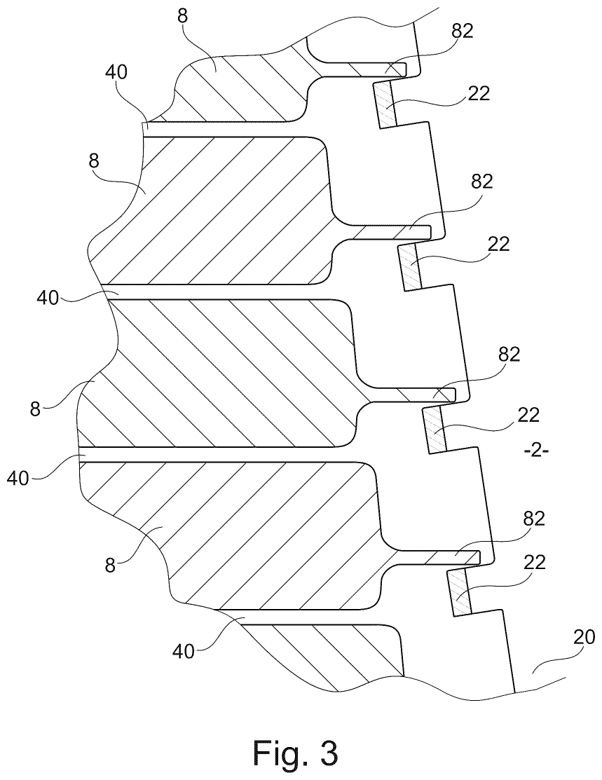

As shown in FIG. 3, the plate-shaped phase change material (PCM) modules 8 are provided with circumferential rims 82 and are accommodated in a rack 20 formed at the side of the inlet section 2 and at the side of the outlet section (not shown in FIG. 3). The rack 20 comprises rail supports 22 for receiving the rims 82 of the PCM modules 8 so that the PCM modules 8 are accommodated with air channels 40 between the modules 8 in the stack. As shown in the figures, the air channels 40 between the PCM plate modules 8 are substantially parallel and providing an airflow in a direction substantially perpendicular to the first airflow direction of the inlet 2.

As shown in the figures, the plurality of plate-shaped phase change material (PCM) modules 8 are mounted in an inclined stacked formation with a shape of a parallelogram. Hereby, a particularly compact design of the PCM heat exchanger apparatus is achieved as the wedge-shaped inlet section 2 and outlet section 6 together with the parallelogram-shaped heat exchanger section form the compact rectangular box-shape.

The inlet section and the outlet section are wedge-shaped with an inclination angle β, which is preferably between 3° and 25° depending on the overall size of the heat exchanger apparatus. The inlet section 2 acts as a manifold and the angle β is particularly selected in order to ensure an evenly distributed airflow through all of the air channels 40 between the PCM plate modules 8 so that all PCM modules are exposed to the airflow evenly and thus exposed to air temperature evenly so that they all change their phase substantially simultaneously. Thus design prevents an uneven temperature distribution along the PCM modules 8, which is to be avoided as otherwise a heated PCM modules 8 may heat neighbouring PCM modules 8 and cause the PCM modules to undergo a phase change and thereby deteriorate the overall cooling effect of the heat exchanger.

As mentioned above, the housing 14 is provided with side covers at least on one side, but preferably on each side (not shown). The side cover retains the plate-shaped PCM modules 8 in said rack and provides an airtight seal between the plate-shaped PCM modules 8. As indicated in FIG. 2, the plate modules 8 can slide in the rack so that the modules 8 are easy to place in the rack and easy to remove for service or replacement.

All of the PCM plate modules 8 can thus easily be exchanged for instance if the heat exchanger is to be configured for a specific temperature. The phase change material of the PCM modules has a specific phase change temperature (PCT). By the invention it is currently preferred that the modules are adapted for undergoing a phase change at 10°-25° Celsius. The particular temperature for the phase change, the phase change temperature (PCT) may be chosen in accordance with the specific requirements for the climate in the building in which the heat exchange system is to be installed. Since the phase change temperature is material specific, accordingly the specific material in the PCM plate modules is also to be chosen for the specific use of the heat exchanger.

An air flow generator, such as an air blower, is provided for controlling an airflow into the inlet channel 2. This air flow generator may be provided upstream the air inlet section 2 in the inlet duct 10 for providing an airflow into the inlet channel 2. Alternatively or additionally, the air flow generator may be provided downstream the outlet section 6 in an outlet duct 12 for providing an airflow through the heat exchanger apparatus.

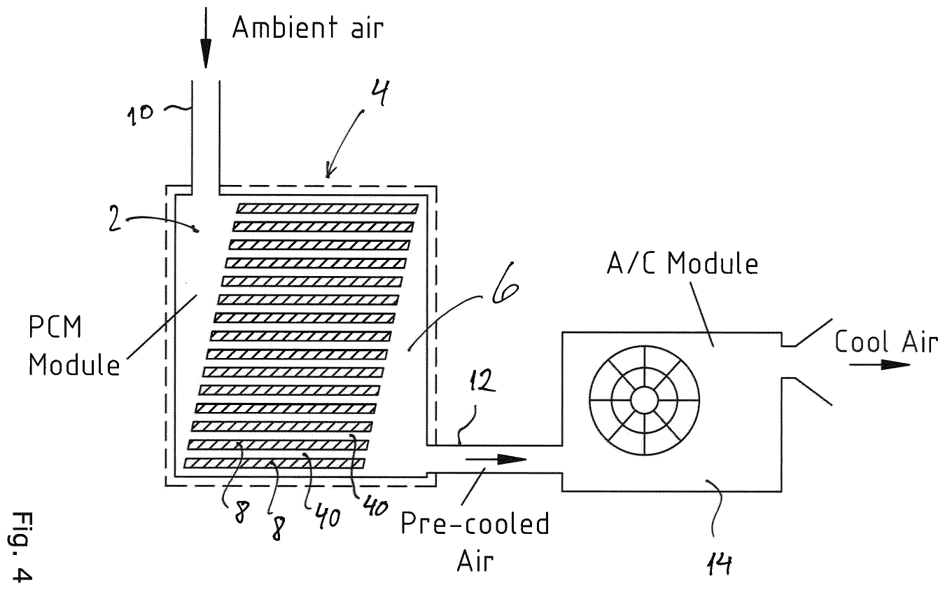

In FIG. 4, there is shown a hybrid PCM-A/C ventilation. The ventilation system comprises a phase change material (PCM) based heat exchanger apparatus as described above with reference to the FIGS. 1-3 and an air-conditioning unit 14.

Incoming ambient air flows through the inlet duct 10 and into the inlet section 2 of the heat exchanger. The air is then distributed so there is a substantially even airflow through the air channels 40 formed by the stacked PCM plate modules 8 of the heat exchanger section 4. The airflows of the air channels 40 are then collected in the outlet section 6 and a pre-cooled airflow exits the PCM heat exchanger apparatus through the outlet duct 12. The pre-cooled air is then fed through an air-conditioning unit 14 where the air can be cooled further if necessary so that cool air is produced which is led into the building structure which is to be temperature regulated.

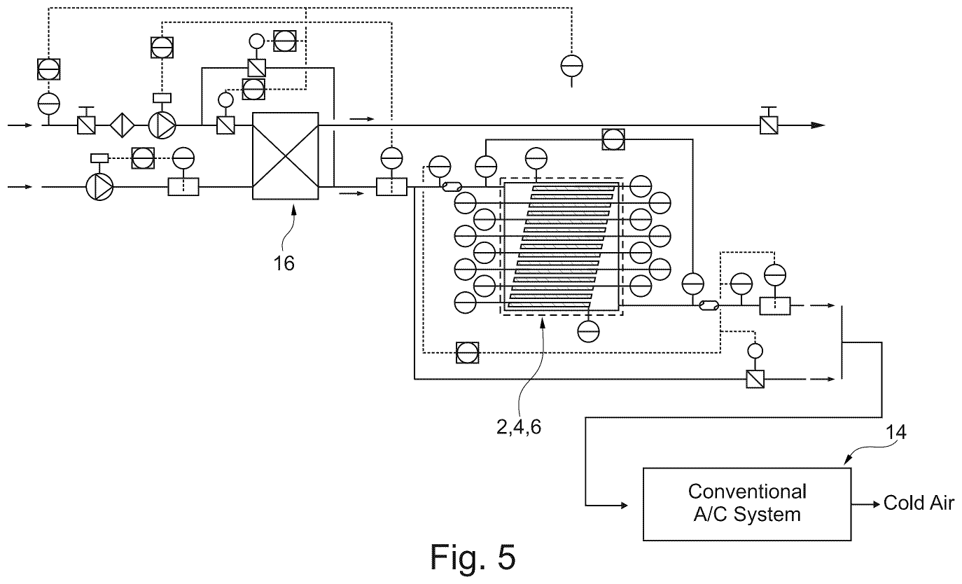

With reference to FIG. 5, a by-pass flow passage may further be provided adapted for the A/C system to receive a by-pass airflow of supply air, which is by-passed the PCM heat exchanger apparatus in addition to the cooled supply air from the PCM heat exchanger apparatus.

By providing the PCM based cooling system in in series with a traditional A/C system, a significant saving in the electricity consumption for cooling and heating a building may be achieved. Only when the cooling power is insufficient from the PCM heat exchanger, the A/C may be turned on. Hereby a significant saving of electrical power may be achieved.

Advantageously, the system further comprises a control unit for controlling the temperatures and the airflows of the PCM heat exchanger as well as controlling the A/C system. By controlling the airflows a precise temperature regulation may be achieved, In particular, by controlling the airflows so that only a partial airflow is exposed to the cooling of the PCM heat exchanger apparatus, and a by-pass airflow circumvents the PCM cooling, the system may also provide a temperature regulation below the temperature of the incoming outside air but above the phase change temperature of the PCM heat exchanger apparatus.

As shown in FIG. 5, the system further comprises a first temperature regulation unit 16 for receiving an incoming outdoor airflow and extract airflow from the building. These airflows are mixed and thereby subjected to a first temperature regulation in accordance with a predetermined room temperature to produce a supply airflow with an intermediate temperature, and an exhaust airflow. The PCM based heat exchanger apparatus may then act as a second temperature regulation unit adapted for receiving the supply airflow. This may provide temperature regulation reusing extracted air from the building to pre-heat or cool the incoming air prior to the PCM heat exchanger system and/or the A/C system.

Above, the invention is described with reference to some currently preferred embodiments. However, by the invention it is realised that other embodiments and variants may be provided without departing from the scope of the invention as defined in the accompanying claims.

Thus, although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. An apparatus for temperature regulation in a building, comprising a housing accommodating an inlet section receiving an airflow in a first direction, and an outlet section with a heat exchange section therebetween, wherein
said inlet section is provided in a first side of the housing, where the inlet section has a wedge-shaped inlet channel having a wide opening at an air inlet and a gradually narrowing cross-section downstream thereof thereby funneling the air downwards in the inlet section, and wherein said inlet channel is provided with a side-opening towards the heat exchange section, and
said heat exchange section comprises a plurality of plate-shaped phase change material (PCM) modules mounted in an inclined stacked formation forming a series of air channels between said PCM modules extending from the inlet section to the outlet section are formed between the PCM modules and so that the airflow is gradually redirected from the inlet section and into the air channels of the heat exchange section, whereby the airflow is subjected to the temperature of the PCM modules before exiting the heat exchange section into the outlet section, and
said outlet section is a wedge-shaped outlet section provided in a second side of the housing opposite the first side and with a side opening receiving the second air flows from the heat exchange section and directing the air to an outlet channel at the wide end of said wedge-shaped outlet section, and that said wedge-shaped outlet section is pointing in an opposite direction than the wedge-shape of the inlet section.

2. An apparatus according to claim 1, wherein the inlet channel has an inclination angle β, preferably β being between 3° and 25°.

3. An apparatus according to claim 1 or 2, wherein the air channels between the PCM plates are substantially parallel and providing an airflow in a second direction substantially perpendicular to the first airflow direction of the inlet.

4. An apparatus according to any of the preceding claims, wherein the outlet section has an inclination angle β, and preferably β being between 3° and 25°.

5. An apparatus according to any one of claims 2 to 4, wherein wedge inclination angle β of the inlet and outlet sections is substantially the same.

6. An apparatus according to any of the preceding claims, wherein the airflow out of the outlet section is substantially in the second airflow direction, and preferably substantially horizontal whereas the first inlet airflow is substantially vertically downwards.

7. An apparatus according to any of the preceding claims, wherein an air flow generator, such as an air blower, is provided for controlling an airflow into the inlet channel.

8. An apparatus according to claim 7, wherein the air flow generator is provided upstream the air inlet section for providing an airflow into the inlet channel.

9. An apparatus according to claim 7 or 8, wherein the air flow generator is provided downstream the outlet section for providing an airflow into the inlet channel.

10. An apparatus according to any of claims 7 to 9, wherein the air flow generator is capable of reversing the airflow through the heat exchanger.

11. An apparatus according to any of the preceding claims, wherein the plate-shaped phase change material (PCM) modules are provided in parallel in the stacked formation.

12. An apparatus according to any of the preceding claims, wherein the apparatus is accommodated in a box-shaped housing and wherein the plurality of plate-shaped phase change material (PCM) modules are mounted in the inclined stacked formation with a shape of a parallelogram.

13. An apparatus according to any of the preceding claims, wherein the plate-shaped phase change material (PCM) modules are provided with circumferential rims and are accommodated in a rack, where the side of the inlet section and the side of the outlet section are provided with rail supports for receiving the rims of the PCM modules.

14. An apparatus according to claim 13, wherein the housing is provided with side covers that retain the plate-shaped PCM modules in said rack and provides an airtight seal between the plate-shaped PCM modules.

15. An apparatus according to any of the preceding claims, wherein the phase change material of the PCM modules is adapted for phase change at 10°-25° Celsius.

16. A ventilation system for temperature regulation in a building or at least a section of the building, said system comprising
a phase change material (PCM) based heat exchanger apparatus according to any one of the preceding claims, said apparatus comprising PCM modules for receiving an incoming airflow wherein the incoming airflow is subjected to the temperature of the PCM modules to cool the airflow;
an electrically powered air conditioning (A/C) system for optionally providing further cooling of at least the cooled supply air to a lower third temperature before reintroducing the air to the building section; and
wherein a by-pass flow passage is provided adapted for the A/C system to receive a by-pass airflow of supply air, which is by-passed the PCM heat exchanger apparatus in addition to the cooled supply air from the PCM heat exchanger apparatus.

17. A ventilation system according to claim 16, further comprising a control unit for controlling the temperatures and the airflows of the PCM heat exchanger as well as controlling the A/C system.

18. A ventilation system according to claim 16 or 17, wherein the system further comprises
a first temperature regulation unit for receiving an incoming outdoor airflow and extract airflow from the building, and wherein said air flows are mixed and thereby subjected to a first temperature regulation in accordance with a predetermined room temperature to produce a supply airflow with an intermediate temperature, and an exhaust airflow; and
a second temperature regulation unit adapted for receiving the supply airflow, wherein said second temperature regulation unit is the PCM based heat exchanger apparatus.

19. A ventilation system according to claim 18, wherein the second temperature regulation unit is an apparatus according to any of the claims 1-15.

20. A method of regulating the temperature in a building or at least a section of the building, wherein an incoming airflow, which at least in a partial airflow is supplied to a PCM based heat exchanger apparatus according to any one of claims 1 to 15, thereby subjecting the airflow to a temperature regulation, such as cooling; and then feeding at least a portion of the airflow to an electrically powered air conditioning system for a third temperature regulation before reintroducing the air to the building section, and whereby a by-pass flow passage is provided so that a by-pass airflow of supply air may be received, which is by-passed the PCM heat exchanger apparatus in addition to the cooled supply air from the PCM heat exchanger apparatus.

21. A method according to claim 20, wherein the incoming airflow is an airflow of outdoor air and an airflow of extract air from the building, which are mixed and thereby subjected to an initial temperature regulation in accordance with a predetermined room temperature to produce the airflow, which at least in a partial airflow is supplied to the PCM based heat exchanger.

22. A method according to claim 20 or 21, whereby the method is performed by a ventilation system according to any one of claims 16 to 19.
